(19) United States
(12) Patent Application Publication
(10) Pub. No.: US 2013/0044731 A1
(43) Pub. Date: Feb. 21, 2013

(54) Proactive Feedback Transmissions During Handover Procedures

(71) Applicants: Guangming Shi, San Diego, CA (US); Tom Chin, San Diego, CA (US); Ta-yan Siu, San Diego, CA (US); Steven D. Cheng, San Diego, CA (US); Kuo-Chun Lee, San Diego, CA (US)

(72) Inventors: Guangming Shi, San Diego, CA (US); Tom Chin, San Diego, CA (US); Ta-yan Siu, San Diego, CA (US); Steven D. Cheng, San Diego, CA (US); Kuo-Chun Lee, San Diego, CA (US)

(73) Assignee: QUALCOMM Incorporated, San Diego, CA (US)

(21) Appl. No.: 13/284,413

(22) Filed: Oct. 28, 2011

Related U.S. Application Data
(60) Provisional application No. 61/523,815, filed on Aug. 15, 2011.

(51) Int. Cl. H04W 36/00

(52) U.S. Cl. 370/331

(57) ABSTRACT

Methods, systems, and devices are described for utilizing proactive feedback information during a handover of a mobile device from a source base station to a target base station. The mobile device may transmit handover messages to the target base station that includes feedback status information, which may include automatic repeat request (ARQ) information elements in some embodiments. The target base station may request that the source base station transmit packets to the target base station based on the received feedback status information. The source base station may transmit handover messages to the mobile device that include feedback status information in some embodiments. Some embodiments may provide for fast resumption of data transmission by utilizing the proactively sent feedback status information from a mobile device to a base station during handover. Some embodiments may reduce the bandwidth for transferring unnecessary data between base stations.

### CROSS-RELATED APPLICATIONS

The present application for patent claims priority to Provisional Application No. 61/523,815 entitled “PROACTIVE FEEDBACK TRANSMISSIONS DURING HANDOVER PROCEDURES” filed Aug. 15, 2011, and assigned to the assignee hereof and hereby expressly incorporated by reference herein.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, WiMAX systems, and orthogonal frequency division multiple access (OFDMA) systems.

Generally, a wireless multiple-access communications system may include a number of base stations, each simultaneously supporting communication for multiple mobile devices. Base stations may communicate with mobile devices on downstream and upstream links. Each base station has a coverage range, which may be referred to as the coverage area of the cell. As a mobile device moves through different coverage ranges of different base stations, the mobile device may be involved with switching communication from one base station to another, which may be referred to as handover. Information may need to be retransmitted in some cases when the mobile device switches communication from one base station to another.

### SUMMARY

Embodiments include methods, systems, and devices for utilizing proactive feedback information during a handover of a mobile device from a source base station to a target base station. The mobile device may transmit handover messages to the target base station that includes feedback status information. The feedback status information may include automatic repeat request (ARQ) information elements. In general, the feedback status information may include information from the mobile device regarding one or more packets that the mobile device has received, one or more packets that the mobile device has not received, one or more packets that the mobile device has sent and received one or more acknowledgements, one or more packets that the mobile device has sent without receiving an acknowledgement, and/or one or more packets that the mobile device has not sent. The base stations may also transmit handover messages that may include feedback status information. The target base station may request that the source base station transmit packets to the target base station based on the received feedback status information.

Some embodiments may allow mobile devices and base stations to quickly know the feedback status information, which may include the status of automatic repeat requests (ARQs). Embodiments may provide for knowing which data packets the mobile devices and/or base stations may start to transmit or retransmit. Some embodiments may provide for fast resumption of data transmission by utilizing the proactively sent feedback status information from a mobile device to a target base station or from a base station to a mobile device or other base station during handover. Some embodiments may reduce the bandwidth for transferring unnecessary data between base stations, such as source base stations and the target base stations.

Some embodiments include a method of utilizing proactive feedback during handover from a source base station to a target base station. The method may include determining, at a mobile device, that a handover is to occur from the source base station to the target base station. After the determination, one or more handover messages including feedback status information may be generated. The one or more handover messages including the feedback status information may be transmitted from the mobile device to the target base station. The handover of the mobile device from the source base station to the target base station may be completed.

The feedback status information may include information from the mobile device regarding at least one or more packets that the mobile device has received, one or more packets that the mobile device has not received, one or more packets that the mobile device has sent and received one or more acknowledgements, one or more packets that the mobile device has sent without receiving an acknowledgement, and/or one or more packets that the mobile device has not sent. Completing the handover of the mobile device from the source base station to the target station may occur after transmitting the one or more handover messages from the mobile device to the target base station.

In some embodiments, the method of utilizing proactive feedback during handover from the source base station to the target base station may further include receiving one or more packets based on the feedback status information that was transmitted as part of the one or more handover messages. Receiving the one or more packets based on the feedback status information that was transmitted as part of the one or more handover messages may include receiving one or more retransmitted packets based on the feedback status information that was transmitted as part of the one or more handover messages. Receiving the one or more retransmitted packets based on the feedback status information that was transmitted as part of the one or more handover messages may include receiving the one or more retransmitted packets from the target base station.

In some embodiments, the method of utilizing proactive feedback during handover from the source base station to the target base station may further include receiving a handover message from the target base station where the handover message from the target base station includes the feedback status information from the handover message from the mobile device.

The one or more handover messages from the mobile device may include a ranging message transmitted to the target base station. The feedback status information may include one or more automatic repeat request information elements. Determining the handover may include the mobile device initiating the handover.

Some embodiments include an apparatus for utilizing proactive feedback during handover from a source base station to a target base station. The apparatus may include: a means for determining that a handover is to occur from the source base station to the target base station; a means for generating, after the determination, one or more handover messages including feedback status information; a means for transmitting the one or more handover messages including the feedback status information to the target base station; and/or a means for completing the handover of the mobile device from the source base station to the target base station.

Some embodiments include a mobile device configured for utilizing proactive feedback during handover from a source base station to a target base station. The mobile device may include a handover module configured to determine that a handover is to occur from the source base station to the target base station to complete the handover of the mobile device from the source base station to the target base station. The mobile device may include a feedback status module configured to generate, after the determination, one or more handover messages including feedback status information. The mobile device may include a transmitter module configured to transmit the one or more handover messages including the feedback status information from the mobile device to the target base station.

The feedback status information may include information from the mobile device regarding at least one or more packets that the mobile device has received, one or more packets that the mobile device has not received, one or more packets that the mobile device has sent and received one or more acknowledgements, one or more packets that the mobile device has sent without receiving an acknowledgement, and/or one or more packets that the mobile device has not sent.

In some embodiments, the mobile device configured for utilizing proactive feedback during handover from the source base station to the target base station may further include a receiver module configured to receive one or more packets based on the feedback status information that was transmitted as part of the one or more handover messages. Receiving the one or more packets based on the feedback status information that was transmitted as part of the one or more handover messages may include receiving one or more retransmitted packets based on the feedback status information that was transmitted as part of the one or more handover messages. Receiving the one or more retransmitted packets based on the feedback status information that was transmitted as part of the one or more handover messages may include receiving the one or more retransmitted packets from the target base station.

Some embodiments include a computer program product for utilizing proactive feedback during handover from a source base station to a target base station that includes a non-transitory computer-readable medium that may include: code for determining, at a mobile device, that a handover is to occur from the source base station to the target base station; code for generating, after the determination, one or more handover messages including feedback status information; code for transmitting the one or more handover messages including the feedback status information from the mobile device to the target base station; and/or code for completing the handover of the mobile device from the source base station to the target base station.

Some embodiments include a method of utilizing proactive feedback during a handover of a mobile device from a source base station to a target base station. The method may include receiving, at the target base station, one or more handover messages including feedback status information from the mobile device; and/or transmitting, from the target base station, one or more messages based on the received feedback status information from the mobile device.

In some embodiments, the method of utilizing proactive feedback during the handover of the mobile device from the source base station to the target base station may further include transmitting a handover message from the target base station to the mobile device, wherein the handover message from the target base station includes the feedback status information from the handover message from the mobile device.

Transmitting the one or more messages based on the received feedback status information from the mobile device may include transmitting a packet request from the target base station to the source base station based on the received feedback status information. Some embodiments may further include: receiving one or more packets from the source base station based on the transmitted packet request; and/or transmitting a handover message from the target base station, wherein the handover message from the target base station includes the feedback status information from the handover message from the mobile device.

Some embodiments include an apparatus configured for utilizing proactive feedback during a handover of a mobile device from a source base station to a target base station. The apparatus may include: a means for receiving, at the target base station, one or more handover messages including feedback status information from the mobile device; and/or a means for transmitting, from the target base station, one or more messages based on the received feedback status information from the mobile device.

Some embodiments include a target base station configured for utilizing proactive feedback during a handover of a mobile device from a source base station to the target base station. The target base station may include a receiver module configured to receive, at the target base station, one or more handover messages including feedback status information from the mobile device. The target base station may include a transmitter module configured to transmit, from the target base station, one or more messages based on the received feedback status information from the mobile device.

Transmitting the one or more messages based on the received feedback status information from the mobile device may include transmitting a packet request from the target base station to the source base station based on the received feedback status information. Some embodiments may further include configuring the target base station to: receive one or more packets from the source base station based on the transmitted packet request; and/or transmit a handover message from the target base station, wherein the handover message from the target base station includes the feedback status information from the handover message from the mobile device.

Some embodiments include computer program product for utilizing proactive feedback during a handover of a mobile device from a source base station to a target base station that includes a non-transitory computer-readable medium that may include: code for receiving, at the target base station, one or more handover messages including feedback status information from the mobile device; and/or code for transmitting, from the target base station, one or more messages based on the received feedback status information from the mobile device.

Some embodiments include method of utilizing proactive feedback during handover. The method may include: determining, at a first base station, that a handover is to occur; determining feedback status information at the first base station; generating, after the determination, one or more handover messages including the determined feedback status information at the first base station; transmitting the one or more handover messages including the determined feedback status information from the first base station to a mobile device; and/or completing the handover of the mobile device.

The feedback status information may include information from the first base station regarding at least one or more packets that the first base station has received, one or more packets that the first base stations has not received, one or more packets that the first base station has sent and received one or more acknowledgements, one or more packets that the first base stations has sent without receiving an acknowledgement, one or more packets that the first base station has not sent, and/or feedback information from the mobile device. Completing the handover may occur after transmitting the one or more handover messages with the feedback status information from the first base station to the mobile device.

In some embodiments, the method of utilizing proactive feedback during handover may further include transmitting one or more messages from the first base station to a second base station based on the determined feedback status information. Transmitting the one or more messages based on the determined feedback status information may include transmitting one or more packets from the first base station to the second base station based on the determined feedback status information. Transmitting the one or more packets from the first base station to the second base station based on the transmitted feedback status information may include transmitting at least one or more new packets or retransmitted packets from the first base station to the second base station based on the determined feedback status information.

In some embodiments, the first base station is a source base station. In some embodiments, the first base station is a target base station. In some embodiments, the first base station is a source base station and the second base station is a target base station. In some embodiments, the first base station is a target base station and the second base station is a source base station.

Some embodiments include an apparatus for utilizing proactive feedback during handover. The apparatus may include: a means for determining that a handover is to occur; a means for determining feedback status information; a means for generating, after the determination, one or more handover messages including the determined feedback status information; a means for transmitting the one or more handover messages including the determined feedback status information from the apparatus to a mobile device; and/or a means for completing the handover of the mobile device.

Some embodiments include a base station configured for utilizing proactive feedback during handover. The base station may include a feedback status module configured to determine feedback status information. The base station may include a handover module configured to: determine that a handover is to occur; generate, after the determination, one or more handover messages including the determined feedback status information at the first base station; and/or complete the handover of the mobile device. The base station may include a transmitter module configured to transmit the one or more handover messages including the determined feedback status information from the first base station to the mobile device.

The feedback status information may include information from the base station regarding at least one or more packets that the base station has received, one or more packets that the base station has not received, one or more packets that the base station has sent and received one or more acknowledgements, one or more packets that the base station has sent without receiving an acknowledgement, one or more packets that the base station has not sent, and/or feedback information from the mobile device.

In some embodiments, the transmitter module may be further configured to transmit one or more messages from the base station to another base station based on the determined feedback status information. Transmitting the one or more messages based on the determined feedback status information may include transmitting at least one or more new packets or retransmitted packets from the base station to the other base station based on the determined feedback status information.

Some embodiments include a computer program product for utilizing proactive feedback during handover that includes a non-transitory computer-readable medium that may include: code for determining, at a base station, that a handover is to occur; code for determining feedback status information at the base station; code for generating, after the determination, one or more handover messages including the determined feedback status information at the base station; code for transmitting the one or more handover messages including the determined feedback status information from the base station to a mobile device; and/or code for completing the handover of the mobile device.

Some embodiments include a method of utilizing proactive feedback during handover. The method may include: determining, at a mobile device, that a handover is to occur; receiving one or more handover messages including feedback status information from a first base station at the mobile device; and/or completing the handover of the mobile device.

The feedback status information may include information from the first base station regarding at least one or more packets that the first base station has received, one or more packets that the first base station has not received, one or more packets that the first base station has sent and received one or more acknowledgements, one or more packets that the first base station has sent without receiving an acknowledgement, one or more packets that the first base station has not sent, and/or feedback information from the mobile device. Completing the handover may occur after receiving the one or more handover messages with the feedback status information from the first base station at the mobile device.

In some embodiments, the method of utilizing proactive feedback during handover may further include transmitting one or more messages from the mobile device station to a second base station based on the received feedback status information. Transmitting the one or more messages based on the received feedback status information may include transmitting one or more packets from the mobile device to the second base station based on the received feedback status information. Transmitting the one or more packets from the mobile device to the second base station based on the transmitted feedback status information may include transmitting at least one or more new packets or retransmitted packets from the mobile device to the second base station based on the received feedback status information.

In some embodiments, the first base station is a source base station. In some embodiments, the first base station is a source base station and the second base station is a target base station.

Some embodiments include an apparatus for utilizing proactive feedback during handover. The apparatus may include: a means for determining, at a mobile device, that a handover is to occur; a means for receiving one or more handover messages including feedback status information from a first base station at the mobile device; and/or a means for completing the handover of the mobile device.

Some embodiments include a mobile device configured for utilizing proactive feedback during handover. The mobile device may include a handover module configured to: determine, at the mobile device, that a handover is to occur; and/or complete the handover of the mobile device. The mobile device may include a receiver module configured to receive one or more handover messages including feedback status information from a first base station at the mobile device.

The feedback status information may include information from the first base station regarding at least one or more packets that the first base station has received, one or more packets that the first base station has not received, one or more packets that the first base station has sent and received one or more acknowledgements, one or more packets that the first base station has sent without receiving an acknowledgement, one or more packets that the first base station has not sent, and/or feedback information from the mobile device. Completing the handover may occur after receiving the one or more handover messages with the feedback status information from the first base station at the mobile device.

In some embodiments, the mobile device configured for utilizing proactive feedback during handover may further include a transmitter module configured to transmit one or more messages from the mobile device station to a second base station based on the received feedback status information. Transmitting the one or more messages based on the received feedback status information may include transmitting one or more packets from the mobile device to the second base station based on the received feedback status information. Transmitting the one or more packets from the mobile device to the second base station based on the transmitted feedback status information may include transmitting at least one or more new packets or retransmitted packets from the mobile device to the second base station based on the received feedback status information.

Some embodiments include a computer program product for utilizing proactive feedback during handover that includes a non-transitory computer-readable medium that may include: code for determining, at a mobile device, that a handover is to occur; code for receiving one or more handover messages including feedback status information from a first base station at the mobile device; and/or code for completing the handover of the mobile device.

The foregoing has outlined rather broadly the features and technical advantages of examples according to disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system in accordance with various embodiments;

FIG. 2 shows a communication diagram of a wireless communications system for providing proactive feedback status information in accordance with various embodiments;

FIG. 3 shows a block diagram of an example of a device with feedback status information and handover functionality in accordance with various embodiments;

FIG. 4 shows a block diagram of an example of a mobile device with feedback status information and handover functionality in accordance with various embodiments;

FIG. 5 shows a block diagram of an example of a base station with feedback status information and handover functionality in accordance with various embodiments;

FIG. 6 shows an example of a handover message in accordance with various embodiments;

FIGS. 7A, 7B, and 7C show several different examples of handover messages in accordance with various embodiments;

FIGS. 8A, 8B, 8C, AND 8D show several different message sequence flow diagrams in accordance with various embodiments;

FIG. 9 is a flowchart of a utilizing proactive feedback during handover from a source base station to a target base station in accordance with various embodiments;

FIG. 10 is a flowchart of a utilizing proactive feedback during handover from a source base station to a target base station in accordance with various embodiments;

FIG. 11 is a flowchart of a utilizing proactive feedback during handover from a source base station to a target base station in accordance with various embodiments; and

FIG. 12 is a flowchart of a utilizing proactive feedback during handover from a source base station to a target base station in accordance with various embodiments.

### DETAILED DESCRIPTION

Embodiments include methods, systems, and devices for utilizing proactive feedback information during a handover of a mobile device from a source base station to a target base station. The mobile device may transmit handover messages to the source base station and/or target base station that include feedback status information. The feedback status information may include automatic repeat request (ARQ) information elements. In general, the feedback status information may include information from the mobile device regarding one or more packets that the mobile device has received, one or more packets that the mobile device has not received, one or more packets that the mobile device has sent and received one or more acknowledgements, one or more packets that the mobile device has sent without receiving an acknowledgement, and/or one or more packets that the mobile device has not sent. The base stations may also transmit handover messages to the mobile device or to each other that may include feedback status information. The target base station may request that the source base station transmit packets to the target base station based on the received feedback status information.

Some embodiments may allow mobile devices and base stations to quickly know the feedback status information, which may include the status of automatic repeat requests (ARQs). Embodiments may provide for knowing which data packets the mobile devices and/or base stations may start to transmit or retransmit. Some embodiments may provide for fast resumption of data transmission by utilizing the proactively sent feedback status information from a mobile device to a base station during handover. Some embodiments may reduce the bandwidth for transferring unnecessary data between base stations, such as source base stations and the target base stations.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes a WiMAX system for purposes of example in some cases, and WiMAX terminology is used in much of the description below, although the techniques are applicable beyond WiMAX applications.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments. The following description uses the terms DTX and discontinuous transmission interchangeably.

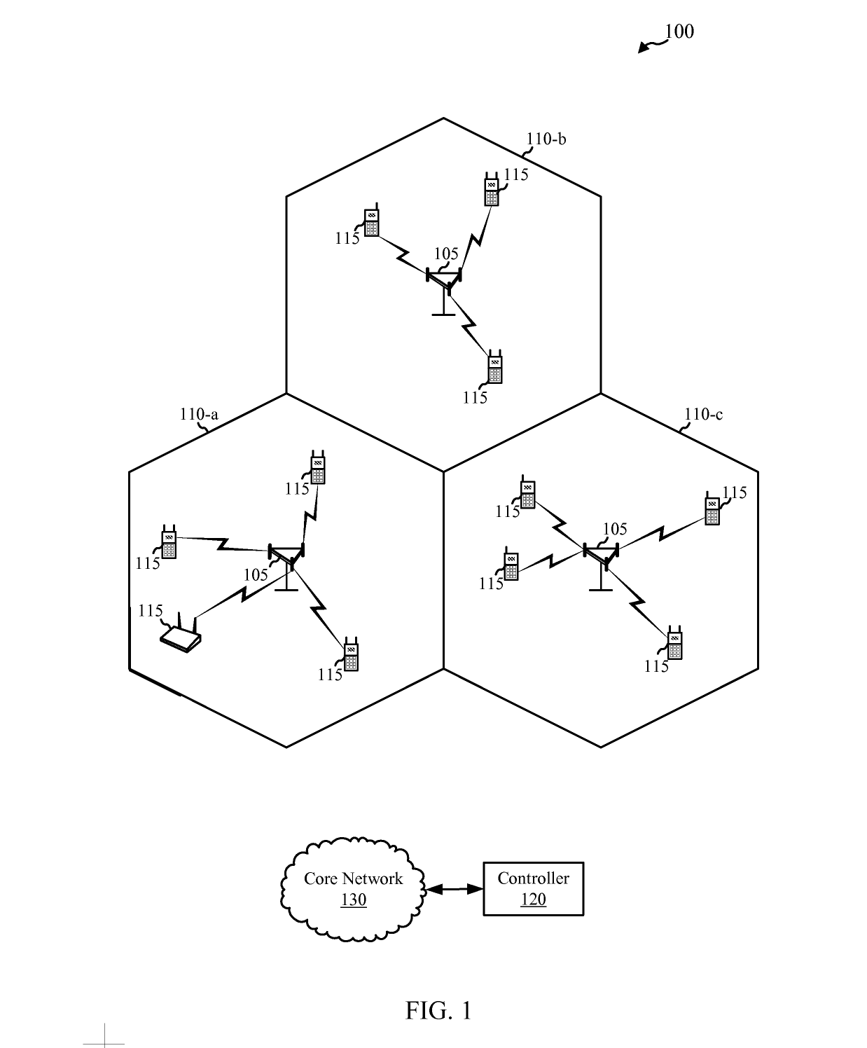

Referring first to FIG. 1, a block diagram illustrates an example of a wireless communications system 100. The system 100 includes base stations 105, mobile devices 115, a base station controller 120, and a core network 130 (the controller 120 may be integrated into the core network 130). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, Time Division Multiple Access (TDMA) signal, Frequency Division Multiple Access (FDMA) signal, Orthogonal FDMA (OFDMA) signal, Single-Carrier FDMA (SC-FDMA) signal, etc. Each modulated signal may be sent on a different carrier and may carry control information (e.g., pilot signals), overhead information, data, etc. The system 100 may be a multi-carrier LTE network capable of efficiently allocating network resources.

The mobile devices 115 may be any type of mobile station, mobile device, access terminal, subscriber unit, or user equipment. The mobile devices 115 may include cellular phones and wireless communications devices, but may also include personal digital assistants (PDAs), smartphones, other handheld devices, netbooks, notebook computers, etc. Thus, the term mobile device should be interpreted broadly hereinafter, including the claims, to include any type of wireless or mobile communications device.

The base stations 105 may wirelessly communicate with the mobile devices 115 via a base station antenna. The base stations 105 may be configured to communicate with the mobile devices 115 under the control of the controller 120 via multiple carriers. Each of the base station 105 sites can provide communication coverage for a respective geographic area. In some embodiments, base stations 105 may be referred to as a Node B or Home Node B. The coverage area for each base station 105 here is identified as 110-a, 110-b, or 110-c. The coverage area for a base station may be divided into sectors (not shown, but making up only a portion of the coverage area). The system 100 may include base stations 105 of different types (e.g., macro, micro, femto, and/or pico base stations). As used herein, the term “cell” may refer to 1) a sector, or 2) a site (e.g., a base station 105). Thus, the term “macrocell” may refer to 1) a macrocell sector, 2) a macrocell base station (e.g., macrocell base station 105), and/or 3) a macrocell controller. Thus, the term “femtocell” may refer to 1) a femtocell sector, or 2) a femtocell base station (e.g., femtocell access point).

For the discussion below, the mobile devices 115 may operate on (are “camped on”) a macro or similar network facilitated by multiple base stations 105. Each base station 105 may cover a relatively large geographic area (e.g., hundreds of meters to several kilometers in radius) and may allow unrestricted access by terminals with service subscription. A portion of the mobile devices 115 may also be registered to operate (or otherwise allowed to operate) in femtocell coverage area (e.g., communicating with femtocell base station 105, which may be referred to as a femtocell access point (FAP) in some cases), within the coverage area of a macrocell base station 105.

By way of example, the femtocell base station 105 may be implemented as a Home Node B (“HNB”) or Home eNode B (HeNB), and located in a user premises, such as a residence, an office building, etc. A macrocell base station may be implemented by a Node B or eNode B in some embodiments.

Wireless communications system 100 may provide for methods, systems, and/or devices for utilizing proactive feedback during handover of a mobile device 115 from one base station 105 to another. A mobile device 115 may determine that a handover is to occur from a first base station 105, such as the base station 105 within coverage area 110-a, to a second target base station 105, such as the base station 105 within coverage area 110-b. After the determination, one or more handover messages including feedback status information may be determined at the mobile device 115. One or more handover messages may be transmitted from the mobile device 115 to at least one of the base stations 105. In some embodiments, the handover message may be transmitted to a target base station 105. The handover of the mobile device 115 from the first base station 105 to the second base station 105 may be completed.

The feedback status information may include information from the mobile device 115 regarding at least one or more packets that the mobile device 115 has received, one or more packets that the mobile device 115 has not received, one or more packets that the mobile device 115 has sent and received one or more acknowledgements, one or more packets that the mobile device 115 has sent without receiving an acknowledgement, and/or one or more packets that the mobile device 115 has not sent.

Completing the handover of the mobile device 115 from the first base station 105 to the second base station 105 may occur after transmitting the one or more handover messages from the mobile device 115 to at least one of the base stations 105. Transmitting the one or more handover messages from the mobile device 115 to at least one of the base stations 105 may include transmitting the one or more handover messages from the mobile device 115 to the second base station 105, which may be referred to as a target base station. In other cases, the mobile device 115 may transmit the one or more handover messages to the first base station 105, which may be referred to as a source base station. In some situations, the mobile device may transmit one or more handover messages to both the first base station 105 and the second base station 105.

In some embodiments, the mobile device 115 may receive one or more packets based on the feedback status information that was transmitted as part of the one or more handover messages. For example, the mobile device 115 may receive one or more retransmitted packets based on the feedback status information that was transmitted as part of the one or more handover messages. In some cases, the mobile device 115 may receive the retransmitted packets from the second base station 105, which may be a target base station.

The mobile device 115 may also receive handover messages from the base stations 105. In some embodiments, the mobile device 115 may receive a handover message from the second base station 105, or target base station, where the handover message includes the feedback status information from the handover message from the mobile device 115.

The one or more handover messages transmitted from the mobile device 115 may include handover messages such a handover confirmation or handover indication message transmitted to the first base station 105 or a ranging message transmitted to the second base station 105, for example. The feedback status information may include one or more automatic repeat request information elements in some embodiments.

In some embodiments, the mobile device 115 may initiate the handover. One of the base stations 105, such as the first base station 105 (e.g. source base station) may initiate the handover.

Base stations 105 may be configured to provide proactive feedback during handover. For example, base station 105 may determine that a handover is to occur. The base station 105 may determine feedback status information. The base station 105 may generate one or more handover messages including the determined feedback status information after the determination. The base station may transmit the one or more handover messages including the determined feedback status information to the mobile device 115.

The feedback status information may include information from the base station 105-c regarding at least one or more packets that the base station 105 has received, one or more packets that the base station 105 has not received, one or more packets that the base station 105 has sent and received one or more acknowledgements, one or more packets that the base station 105 has sent without receiving an acknowledgement, one or more packets that the base station 105 has not sent, or feedback information from the mobile device 115.

As discussed above, the mobile device 115 may transmit and/or receive different handover messages with respect to one or more base stations 105, where some of these handover messages may include feedback status information that may be utilized proactively as part of handover. For example, the first base station 105 may transmit one or more packets to the second base station based on the received feedback status information. This may include transmitting new packets and/or retransmitted packets from the first base station 105 to the second base station 105 based on the received feedback status information from the mobile device 115.

In some cases, the second base station 105 may transmit one or more packet requests to the first base station 105 based on the received feedback status information. The second base station 105 may then receive one or more packets from the first base station 105 based on the transmitted packet request. The second base station 105 may also transmit handover message(s) to the mobile device 115 that may include the feedback status information from the handover message from the mobile device 115.

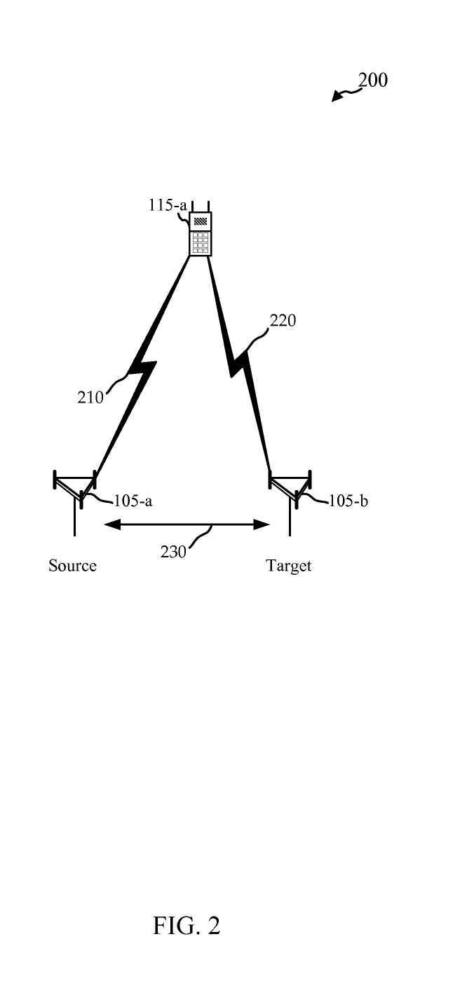

FIG. 2. illustrates portions of a sample communications system 200 that may illustrate aspects of communication between the mobile device 115 and base stations 105 in accordance with various embodiments. Communications system 200 may represent part of system 100 of FIG. 1, for example. System 200 may include multiple base stations 105 and/or mobile devices 115. For clarity purposes, system 200 shows two base stations 105-a and 105-b, where base station 105-a is referred to as source base station and base station 105-b is referred to as a target base station. Source base station 105-a may be an example of the first base station 105 and target base station 105-b may be an example of the second base station 105 as described above with respect to system 100 of FIG. 1.

Mobile device 115-a may communicate with source base station 105-a through wireless communication 210. Mobile device 115-a may communicate with target base station 105-b through wireless communication 220. In addition, source base 105-a may communicate with target base station 105-b through communications link 230. In some cases, communications link 230 may include communicating through a core network. In some embodiments, communications link 230 may include a more direct link, such as an LTE X2 interface between source base station 105-a and target base station 105-b.

For example, source base station 105-a may receive a handover request from the mobile device 115-a through wireless communication 210. In some embodiments, when a handover is triggered, the mobile device 115-a may exchange MAC management messages with the source base station 105-a. The handover request may include a MOB_MSHO-REQ in some embodiments. The source base station 105-a may then transmit a handover response to the mobile device 115-a through wireless communication 210, which may be a MOB_BSHO-RSP in some embodiments. The mobile device 115-a may transmit a handover conformation or indication message through wireless communication 210 to the source base station 105-a that may include feedback status information. In some embodiments, the mobile device 115-a may transmit a MOB_HO-IND message with automatic repeat request (ARQ) Feedback information element(s) (IE). Having received feedback status information, such as ARQ Feedback IEs, the source base station 105-a may know what information, such as SDUs in some embodiments, to transfer to the target base station 105-b over communications link 230. Since the transfer can be done upon receiving a handover indication message, such as MOB_HO-IND message, the data transmission, such as MPDU transmission, can resume quickly at the target base station 105-b. The mobile device 115-a may change its channel to the target base station 105-b.

In some embodiments, the mobile device 115-a may perform an optimized network reentry procedure with the target base station 105-b. The mobile device 115-a may receive information from the target base station 105-b, such as Fast Ranging IEs in some embodiments, from the target base station 105-b to allocate an uplink data burst for the mobile device 115-a to send handover messages to the target base station 105-b.

In some embodiments, the target base station 105-b may receive a handover request with feedback status information from the mobile device 115-a through wireless communication 220. In some embodiments, the handover request message may include a ranging request message such as RNG-REQ. The target base station 105-b may then transmit a handover response message to the mobile device 115-a through the wireless communication 220. This handover response may include the feedback status information that the target base station 105-b may have received from the mobile device 115-a and/or the source base station 105-a in some cases. In some embodiments, the handover response message may include a ranging response message such as RNG-RSP. In some embodiments, this exchange of messages between the mobile device 115-a and the target base station 105-b may include ranging messages that may include ARQ Feedback IE(s). Through the exchange of feedback status information, the mobile device 115-a and/or the target base station 105-b may know what packets may need to be transmitted, such as which ARQ blocks may be transmitted. In some cases, the target base station 105-b may send a packet request over communications link 230 to the source base station 105-a based on the feedback status information it receives from the mobile device 115-a.

In some embodiments, the target base station 105-b may receive a handover request with feedback status information from the mobile device 115-a through wireless communication 220 that may involve an uncontrolled handover in which the source base station 105-a may not receive or may receive a handover message from the mobile device 115-a. The mobile device 115-a may perform a handover search through wireless communication 220, which may include performing handover ranging with respect to the target base station 105-b. In some embodiments, the handover search may include transmitting a handover ranging code to the target base station 105-b. The target base station 105-b may transmit a handover search response to the mobile device 115-a. In some embodiments, this handover search response may include a UL-MAP, which may include allocation information elements (e.g., CDMA Allocation IE). The mobile device 115-a may transmit a handover request message to the target base station 105-b, which may include a ranging request message. The handover request message may include information regarding the source target base station 105-a, such as source base station identification (BSID) information. The handover request message may also include feedback status information, which may be ARQ Feedback IE(s) in some embodiments.

With feedback status information, the target base station 105-b may know which source base station 105-a it may want to communicate with to request data transfers. This communication between the target base station 105-b and the source base station 105-a may occur over communications link 230. In addition, the target base station 105-b may know what data, such as SDUs, it may want transferred from the source base station 105-a to the target base station 105-b based on the feedback status information. The target base station 105-b may transmit a handover response message to the mobile device 115-a. This handover response message may include the feedback status information that it may have received from the mobile device 115-a and/or the source base station 105-a in some cases. The handover response message may include a ranging response message with ARQ Feedback IE(s) in some embodiments. The mobile device 115-a and the target base station 105-b may then transmit data between each other, which may include MPDUs in some embodiments.

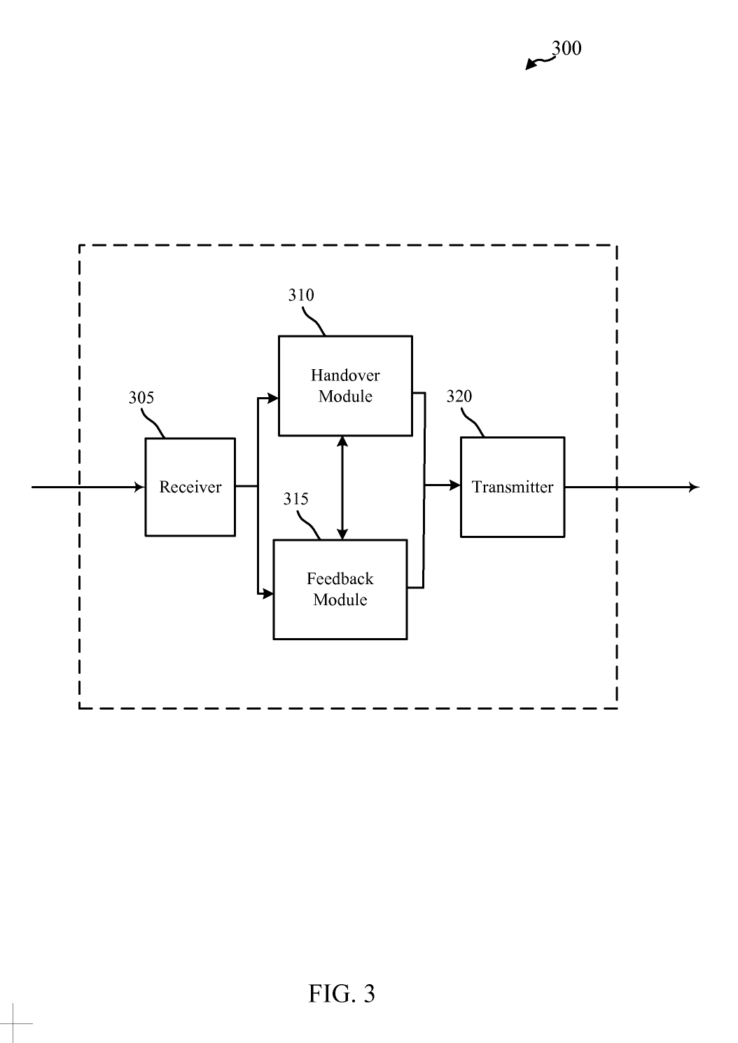

Turning next to FIG. 3, a block diagram illustrates a device 300 that includes feedback and handover functionality. The device 300 may be an example of the mobile device 115 or 115-a described with reference to FIG. 1 and/or FIG. 2 respectively, and/or may be a device integrating the feedback functionality (e.g., base stations 105 of FIGS. 1-2). The device 300 may also be a processor. The device 300 may include a receiver module 305, a handover module 310, a feedback module 315, and/or a transmitter module 320. Each of these components may be in communication with each other.

These components of the device 300 may, individually or collectively, be implemented with one or more application specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 305 may receive information such as packet and/or data information regarding what device 300 has received or transmitted. In some cases, receiver 305 may also receive handover information. The received information may be utilized by the feedback module 315 and/or the handover module 310 for a variety of purposes in accordance with various embodiments. For example, the feedback module 315 may utilize received information to determine and/or generate feedback status information. The handover module 310 may generate different forms of handover messages, which may incorporate the feedback status information generated by the feedback module 315. The transmitter module 320 may then transmit the handover messages to other components and/or devices, such a mobile device 115 and/or base stations 105.

In some embodiments, feedback module 315 and/or handover module 310 may be configured to receive handover messages and/or feedback status information. The feedback module 315 may then determine information based on the feedback status information received in order to determine information, such as packets, that it may want to request from another device, such as a base station 105. The feedback module 315 and/or the handover module 310 may generate request messages accordingly that the transmitter module 320 may then transmit in order to request the information from another device, such as another base station 105.

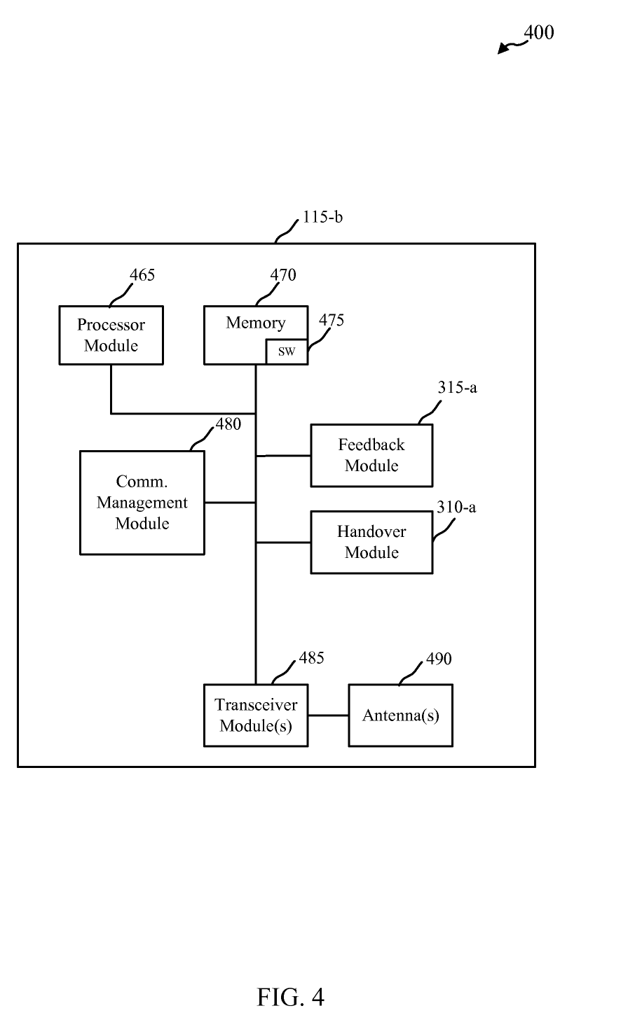

FIG. 4 shows a block diagram 400 of mobile device 115-b that may be an example of the mobile devices 115 described with reference to FIG. 1, FIG. 2, and/or FIG. 3. The mobile device 115-b may have any of various configurations, such as personal computers (e.g., laptop computers, net book computers, tablet computers, etc.), cellular telephones, PDAs, digital video recorders (DVRs), internet appliances, gaming consoles, e-readers, etc. For the purpose of clarity, the mobile device 115-b is assumed to be provided in a mobile configuration, having an internal power supply (not shown), such as a small battery, to facilitate mobile operation.

The mobile device 115-b may include antenna(s) 490, transceiver module(s) 485, a feedback module 315-a, handover module 310-a, memory 470, and a processor module 465 which each may be in communication, directly or indirectly, with each other (e.g., via one or more buses). The transceiver module(s) 485 may be configured to communicate bi-directionally, via the antenna(s) 490 with base stations 105. Transceiver module(s) 485 may include a modem configured to modulate the packets and provide the modulated packets to the antennas 490 for transmission, and to demodulate packets received from the antennas 490. While the mobile device 115-b may include a single antenna, the mobile device 115-b may include multiple antennas 490 for multiple links. The feedback module 315-a may be an example of the feedback module 315 of device 300 of FIG. 3. The handover module 310-a may be an example of the handover module 310 of device 300 of FIG. 3.

The memory 470 may include random access memory (RAM) and read-only memory (ROM). The memory 470 may store computer-readable, computer-executable software code 475 containing instructions that are configured to, when executed, cause the processor module 465 to perform various functions described herein (e.g., call processing, database management, message routing, etc.). Alternatively, the software 475 may not be directly executable by the processor module 465 but be configured to cause the computer (e.g., when compiled and executed) to perform functions described herein.

The processor module 465 may include an intelligent hardware device, e.g., a central processing unit (CPU) such as those made by Intel® Corporation or AMD®, a microcontroller, an application specific integrated circuit (ASIC), etc. The processor module 465 may include a speech encoder (not shown) configured to receive audio via a microphone, convert the audio into packets (e.g., 30 ms in length) representative of the received audio, provide the audio packets to the transceiver module(s) 485, and provide indications of whether a user is speaking. Alternatively, an encoder may only provide packets to the transceiver module(s) 485, with the provision or withholding/suppression of the packet itself providing the indication of whether a user is speaking.

According to the architecture of FIG. 4, the mobile device 115-b further includes a communications management module 480. The communications management module 480 may manage communications with base stations 105 and/or other mobile devices 115 (e.g., acting as a master of a secondary piconet), etc. By way of example, the communications management module 480 may be a component of the mobile device 115-b in communication with some or all of the other components of the mobile device 115-b via a bus. Alternatively, functionality of the communications management module 480 may be implemented as a component of a transceiver module(s) 485, as a computer program product, and/or as one or more controller elements of the processor module 465.

Some components of the mobile device 115-b may, individually or collectively, be implemented, in whole or in part, with instructions embodied in a memory, formatted to be executed by one or more general or application-specific processors. They may also be implemented with one or more application specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art.

Mobile device 115-b may be utilized for providing proactive feedback during handover of the mobile device 115-b from one base station 105 to another. For example, the handover module 310-a may determine that a handover is to occur from a first base station 105, such as the base station 105 within coverage area 110-a, to a second base station 105, such as the base station 105 within coverage area 110-b. After the handover determination, the handover module 310-a may generate one or more handover messages that include feedback status information that the feedback module 315-a may determine and/or generate. In some embodiments, the handover messages generated by the handover module 310-a may include, but are not limited to, MOB_MSHO-REQ, MOB_HO-IND, and/or RNG-REQ messages. The handover messages produced by handover module 310-a may be transmitted through transceiver module(s) 485 and antenna(s) 490 to at least one of the base stations 105, such as the target base station 105. The handover of the mobile device 115 from the first base station 105 to the second base station 105 may be completed.

The feedback module 315-a may determine and/or generate feedback status information that may include information from the mobile device 115-b regarding at least one or more packets that the mobile device 115-b has received, one or more packets that the mobile device 115-b has not received, one or more packets that the mobile device 115-b has sent and received one or more acknowledgements, one or more packets that the mobile device 115-b has sent without receiving an acknowledgement, or one or more packets that the mobile device 115-b has not sent.

Completing the handover of the mobile device 115-b from the first base station 105 to the second base station 105 may occur after transmitting the one or more handover messages from the mobile device 115-b to at least one of the base stations 105. Transmitting the one or more handover messages from the transceiver module(s) 485 and antenna(s) 490 of the mobile device 115-b to at least one of the base stations 105 may include transmitting the one or more handover messages from the mobile device 115-b to the second base station 105, which may be referred to as a target base station. In other cases, the mobile device 115-b may transmit the one or more handover messages to the first base station 105, which may be referred to as a source base station. In some situations, the mobile device 115-b may transmit one or more handover messages to both the first base station 105 and the second base station 105.

In some embodiments, the antenna(s) 490 of the mobile device 115-b may receive one or more packets based on the feedback status information that was transmitted as part of the one or more handover messages. For example, the mobile device 115-b may receive one or more retransmitted packets based on the feedback status information that was transmitted as part of the one or more handover messages. In some cases, the mobile device 115-b may receive the retransmitted packets from the second base station 105, which may be a target base station.

The mobile device 115-b may also receive handover messages from the base stations 105. In some cases, the handover module 310-a may utilize these received handover messages. In some embodiments, the mobile device 115-b may receive a handover message from the second base station 105, or target base station, where the handover message includes the feedback status information from the handover message from the mobile device 115-b.

The one or more handover messages generated by the handover module 310-a transmitted from the mobile device 115-b may include handover messages such as a handover confirmation or handover indication message transmitted to the first base station 105 or a ranging message transmitted to the second base station 105, for example. The feedback status information generated by the feedback module 315-a may include one or more automatic repeat request information elements in some embodiments.

In some embodiments, the handover module 310-a may facilitate the mobile device 115-b initiating the handover.

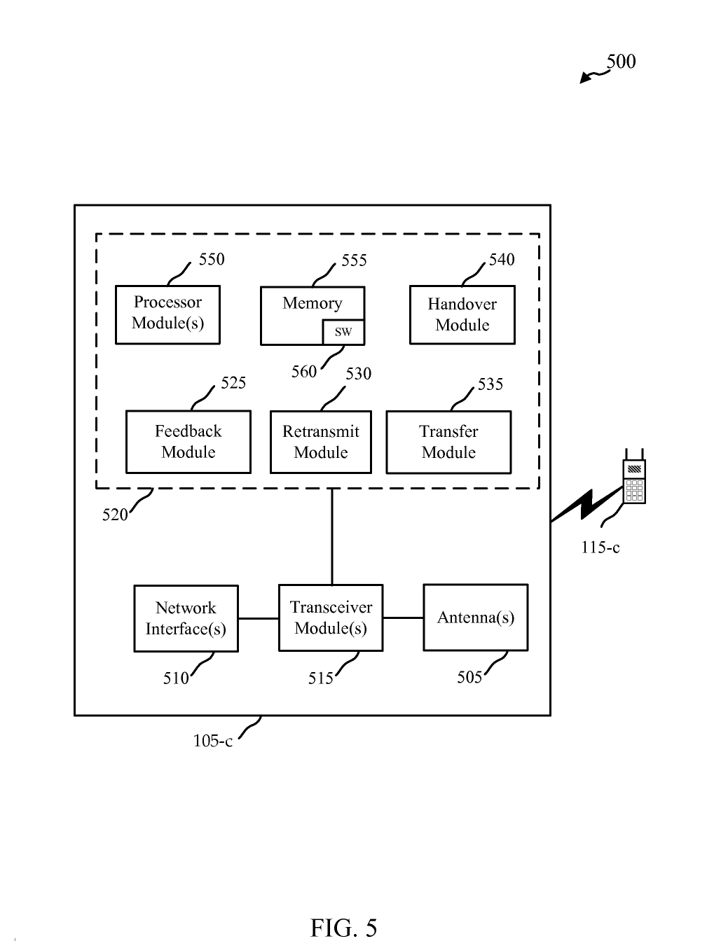

Turning next to FIG. 5, a block diagram illustrates a wireless communication system 500 which includes a mobile device 115-c and base station 105-c. The system 500 may be an example of the system 100, 200 described with reference to FIG. 1 or 2. Thus, the base station 105-c may be an example of the base stations 105 of FIG. 1, the source base station 105-a of FIG. 2, or the target base station 105-b of FIG. 2. Any subset of these components may be located in the controller 120 of FIG. 1, as well. The base station 105-c may include wireless (antenna(s) 505) and wired (network interface(s) 510) connectivity, and one or more transceiver module(s) 515. These communications components may be communicatively coupled with any subset of the following components 520: a feedback module 525, a retransmit module 530, a transfer module 535, a handover module 540, memory 555 (software 560), and processor module(s) 550. The mobile device 115-c may be an example of the mobile device 115 of FIG. 1, 2, 3, or 4.

These components 520 of the base station 105-c may, individually or collectively, be implemented with one or more application specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

As discussed above, a mobile device 115, including mobile device 115-c, may transmit and/or receive different handover messages with respect to one or more base stations 105, such as base station 105-c. The handover messages may include feedback status information that may be utilized proactively as part of handover. For example, the retransmit module 530 and/or transfer module 535 may generate and/or transmit one or more packets to another base station-based transceiver module(s) 515 and network interface(s) 510 (or antenna(s) 505 in some cases) based on the received feedback status information. In some cases, the feedback module 525 may utilize and/or process the received feedback status information in order that the other modules of components 520 may utilize this information. The retransmit module 530 and/or the transfer module 535 may transmit new packets and/or retransmitted packets from the base station 105-c to another base station 105 based on the received feedback status information from the mobile device 115-c.

In some cases, the retransmit module 530 and/or the transfer module 535 may generate and/or transmit one or more packet requests to another base station 105 based on the received feedback status information. The other base station 105 may then receive one or more packets from the base station 105-c based on the transmitted packet request.

The handover module 540 may generate different handover messages. For example, the handover module 540 may generate and/or transmit handover message(s) to the mobile device 115-c through the transceiver module(s) 515 and antenna(s) 505 that may include the feedback status information from the handover message from the mobile device 115-c. In some embodiments, the handover module 540 may generate handover messages including, but not limited to, MOB_BSHO-RSP, RNG-RESP, and/or UL-MAP messages.

Base station 105-c may be configured to provide proactive feedback during handover. For example, the handover module 540 may determine that a handover is to occur. The feedback module 525 may determine feedback status information. The handover module 540 may generate one or more handover messages including the determined feedback status information after the determination. The transceiver module 515 and/or antennas 505 may transmit the one or more handover messages including the determined feedback status information to the mobile device 115-c.

The feedback status information determined at the feedback module 525 may include information from the base station 105-c regarding at least one or more packets that the base station 105-c has received, one or more packets that the base station 105-c has not received, one or more packets that the base station 105-c has sent and received one or more acknowledgements, one or more packets that the base station 105-c has sent without receiving an acknowledgement, one or more packets that the base station 105-c has not sent, or feedback information from the mobile device 115-c. The handover module 540 may complete the handover after transmitting the one or more handover messages with the feedback status information from the base station 105-c to the mobile device 115-c.

In some embodiments, the base station 105-c may transmit one or more messages from the base station 105-c to another base station 105 (not shown) based on the determined feedback status information. For example the retransmit module 520 and/or transfer module 535 may be utilized for transmitting the one or more messages based on the determined feedback status information that include transmitting one or more packets from the base station 105-c to the other base station 105 based on the determined feedback status information. The retransmit module 520 and/or transfer module 535 may be utilized for transmitting the one or more packets from the base station 105-c to the other base station 105 based on the transmitted feedback status information that may include transmitting at least one or more new packets or retransmitted packets from the base station 105-c to the other base station 105 based on the determined feedback status information.

In some embodiments, the base station 105-c is a source base station. In some embodiments, the base station 105-c is a target base station. In some embodiments, the base station 105-c is a source base station and the other base station 105 is a target base station. In some embodiments the base station 105-c is a target base station and the other base station 105 is a source base station.

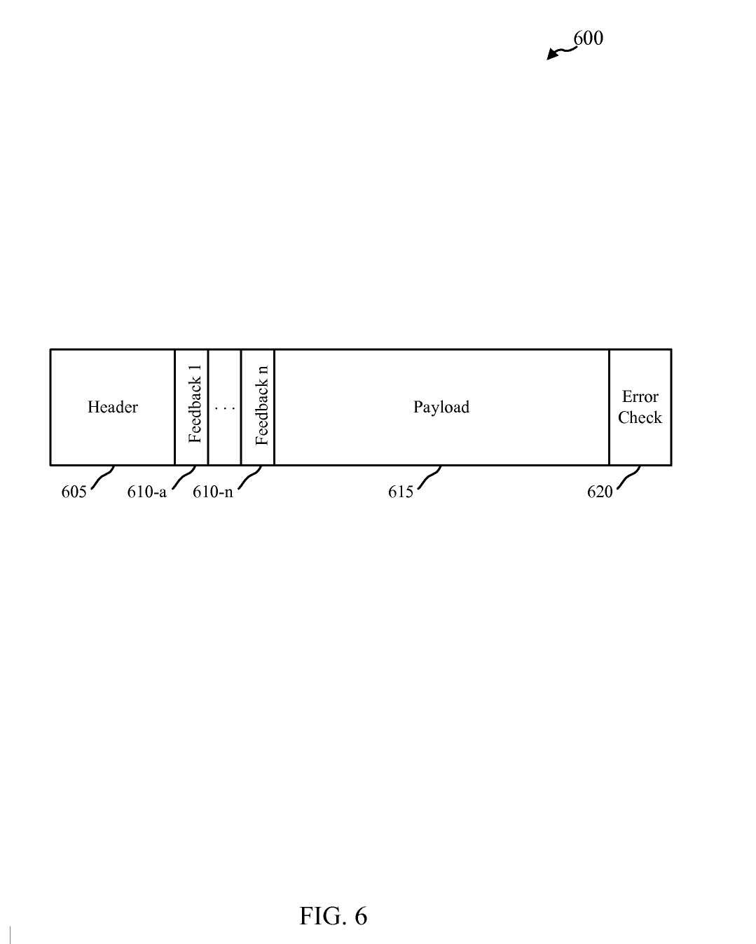

FIG. 6 shows an example of a general handover message 600 in accordance with various embodiments. Handover message 600 may be generated and/or utilized by different devices and/or systems, such as base stations 105 of FIG. 1, mobile devices 115 of FIG. 1, base stations 105-a and/or 105-b of FIG. 2, mobile device 115-a of FIG. 2, device 300 of FIG. 3, mobile device 115-b of FIG. 4, mobile device 115-c of FIG. 5, and/or base station 105-c of FIG. 5. Handover message 600 may include a header 605. In some embodiments, the header 605 may include a MAC protocol data unit (MPDU). Handover message 600 may include one or more feedback status information 610-a, . . . , 610-n. The feedback status information 610 may include a variety of information including, but not limited to, information from the mobile device 115 regarding at least one or more packets that the mobile device 115 has received, one or more packets that the mobile device 115 has not received, one or more packets that the mobile device 115 has sent and received one or more acknowledgements, one or more packets that the mobile device 115 has sent without receiving an acknowledgement, or one or more packets that the mobile device 115 has not sent. Feedback status information 610 may be considered as a subheader of handover message 600 in some cases. Handover message 600 may also include a payload 615. Payload 615 may include different information regarding the handover messaging including, but not limited to, handover indication or commitment information, handover request information, handover response information, and/or ranging information. In some embodiments, payload 615 may include messaging such as mobile handover indication (MOB_HO-IND) message information, ranging request (RNG-REQ) message information, and/or ranging response (RNG-RSP) message information. Handover message 600 may also include error check information 620. Error check information 620 may include, for example, a cyclic redundancy check (CRC) or other information (e.g., checksum) to check for errors in the handover message 600. Handover message 600 may be utilized by mobile device 115 and/or base stations 105 in different embodiments.

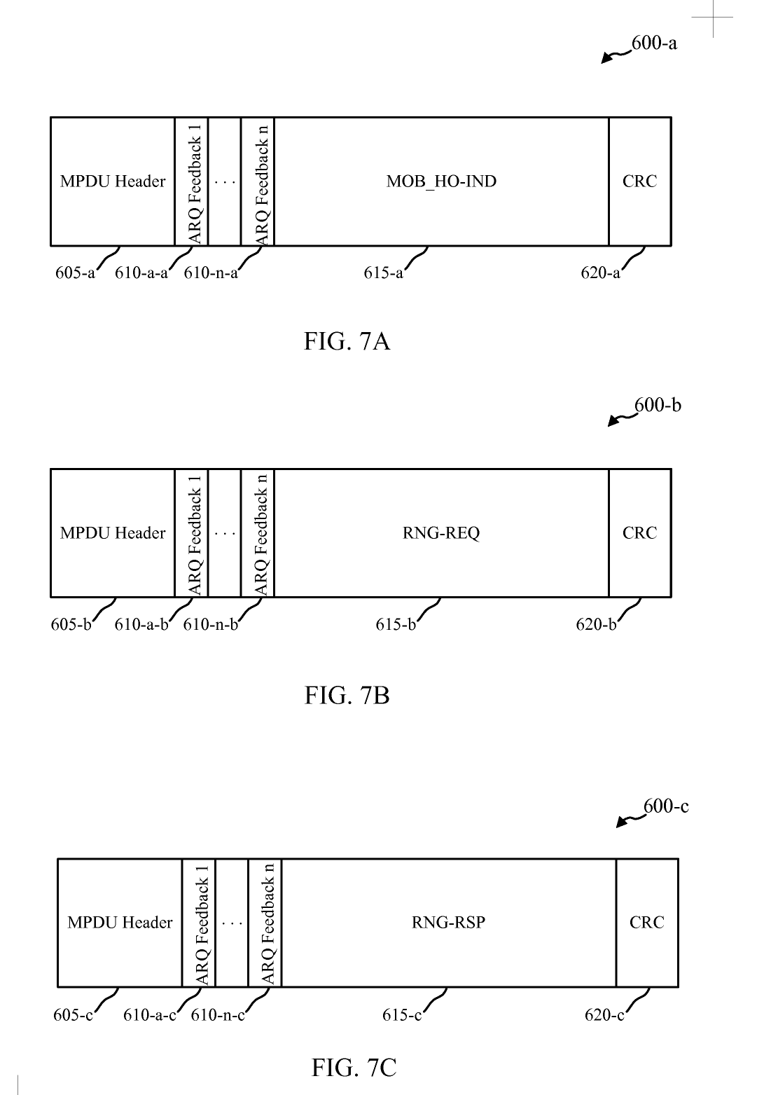

For example, FIGS. 7A, 7B, and 7C provide several different examples of different handover messages 600-a, 600-b, and 600-c. These handover messages are provided as examples associated with several embodiments. Other embodiments may utilize different handover message formats within the spirit of the invention.

FIG. 7A provides an example of a handover message 600-a in accordance with various embodiments. Handover message 600-a may be an example of handover message 600 of FIG. 6. Handover message 600-a may be generated and/or utilized by different devices and/or systems, such as mobile devices 115 of FIG. 1, mobile device 115-a of FIG. 2, device 300 of FIG. 3, mobile device 115-b of FIG. 4, and/or mobile device 115-c of FIG. 5. Handover message 600-a may be an example of a mobile handover indication message that a mobile device 115 may transmit to a base station 105, such as a source base station 105-a of FIG. 2. A mobile device 115 may utilize handover message 600-a to piggyback feedback status information into a handover message. The status feedback information may include one or more automatic repeat request (ARQ) Feedback information elements (IEs) 610-a-a, . . . , 610-n-a.

Handover message 600-a may include a header 605-a, which may be a MAC protocol data unit (MPDU) header. The ARQ Feedback IE(s) 610-a-a, . . . , 610-n-a may comprise a subheader in this handover message 600-a to indicate the current ARQ status for a downlink (DL) transport connection. There may be multiple ARQ Feedback IEs 610-a-a, . . . , 610-n-a, each for a DL transport connection. Handover message 600-a may also include mobile handover indication message (MOB_HO-IND) 615-a as a payload. In addition, handover message 600-a may include cyclic redundancy check (CRC) 620-a information.

When a base station 105, such as a source base station 105-a, receives handover message 600-a that includes the ARQ Feedback IE(s) along with MOB_HO-IND 615-a, it may transfer packets, such as service data units (SDUs) that may be buffered in a source base station transmission queue with some ARQ blocks not yet transmitted and wait for retransmission to a target base station, such as target base station 105-b, as indicated by the ARQ Feedback IE(s) 610-a-a, . . . , 610-n-a. This process may avoid unnecessary data transfer between a source base station and a target base station.

FIG. 7B provides an example of a handover message 600-b in accordance with various embodiments. Handover message 600-b may be an example of handover message 600 of FIG. 6. Handover message 600-b may be generated and/or utilized by different devices and/or systems, such as mobile devices 115 of FIG. 1, mobile device 115-a of FIG. 2, device 300 of FIG. 3, mobile device 115-b of FIG. 4, and/or mobile device 115-c of FIG. 5. Handover message 600-b may be an example of a ranging request message that a mobile device 115 may transmit to a base station 105, such as a target base station 105-b of FIG. 2. A mobile device 115 may utilize handover message 600-b to piggyback feedback status information into a handover message. The status feedback information may include one or more automatic repeat request (ARQ) Feedback information elements (IEs) 610-a-b, . . . , 610-n-b.

Handover message 600-b may include a header 605-b, which may be a MAC protocol data unit (MPDU) header. The ARQ Feedback IE(s) 610-a-b, . . . , 610-n-b may comprise a subheader in this handover message 600-b to indicate the current ARQ status for a downlink (DL) transport connection. There may be multiple ARQ Feedback IEs 610-a-b, . . . , 610-n-b, each for a DL transport connection. Handover message 600-b may also include ranging request message (RNG-REQ) 615-b as a payload. In addition, handover message 600-b may include cyclic redundancy check (CRC) 620-b information.

When a mobile device 115 starts a ranging procedure, for example with a target base station 105, the mobile device 115 may send the RNG-REQ message 615-b with the piggyback ARQ Feedback IE(s) 610-a-b, . . . , 610-n-b. In some situations, the handover message 600-b may provide a second time that the target base station 105 may receive with the ARQ status of the DL transport connection. In some cases, handover message 600-b may be important especially when a mobile device 115 performs an uncontrolled handover in which the source base station does not receive the MOB_HO-IND message, such as handover message 600-a of FIG. 7A.

FIG. 7C provides an example of a handover message 600-c in accordance with various embodiments. Handover message 600-c may be an example of handover message 600 of FIG. 6. Handover message 600-c may be generated and/or utilized by different devices and/or systems, such as base stations 105 of FIG. 1, base stations 105-a and/or 105-b of FIG. 2, device 300 of FIG. 3, and/or base station 105-c of FIG. 5. Handover message 600-c may be an example of a ranging request message that a target base station 105 may transmit to a mobile device 115. A base station 105 may utilize handover message 600-c to piggyback feedback status information into a handover message. The status feedback information may include one or more automatic repeat request (ARQ) Feedback information elements (IEs) 610-a-c, . . . , 610-n-c.

Handover message 600-c may include a header 605-c, which may be a MAC protocol data unit (MPDU) header. The ARQ Feedback IE(s) 610-a-c, . . . , 610-n-c may comprise a subheader in this handover message 600-c to indicate the current ARQ status for a uplink (UL) transport connection. There may be multiple ARQ Feedback IEs 610-a-c, . . . , 610-n-c, each for a UL transport connection. Handover message 600-c may also include ranging response message (RNG-RSP) 615-c as a payload. In addition, handover message 600-c may include cyclic redundancy check (CRC) 620-c information.

In some embodiments, a base station 105, such as the target base station 105-b of FIG. 2, may transmit the handover message 600-c as a ranging response message to a mobile device 115. In some situations, the handover message 600-c may be sent with handover optimization information such as HO Process Optimization TLV. There may be connection identifier (CID) update information in the RNG-RSP message 615-c. The ARQ Feedback IE(s) 610-a-c, . . . , 610-n-c may now refer to the new transport CID to be used.

The mobile device 115 may start to transmit data to the target base station 105 after receiving the handover message 600-c. For example, the mobile device 115 may start transmitting UL MPDU with new or retransmitted ARQ blocks after receiving the RNG-RSP message 615-c. The target base station 105 may also start to transmit data to the mobile device 115. For example, the target base station 105 may transmit DL MPDU with new or retransmitted ARQ blocks.

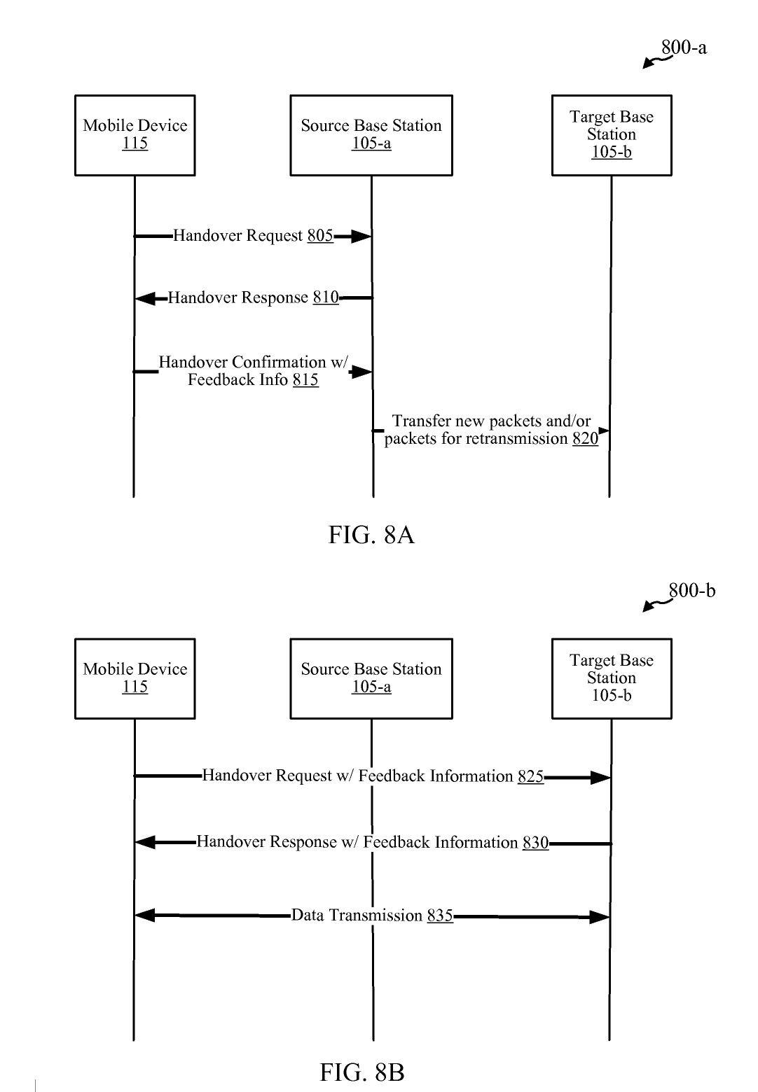

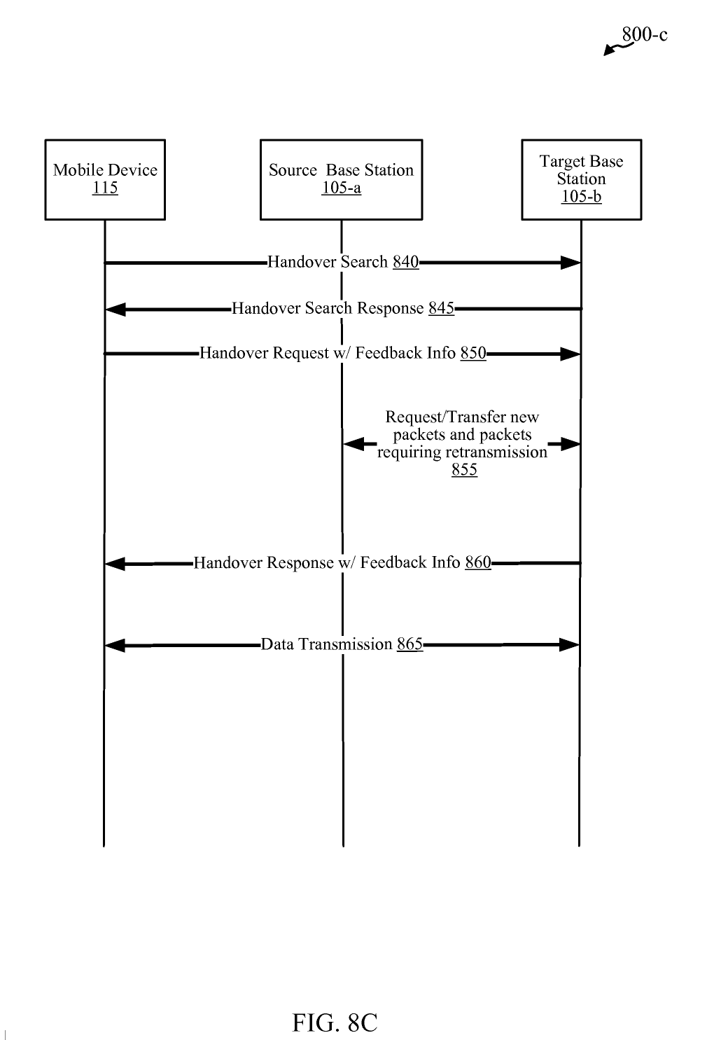

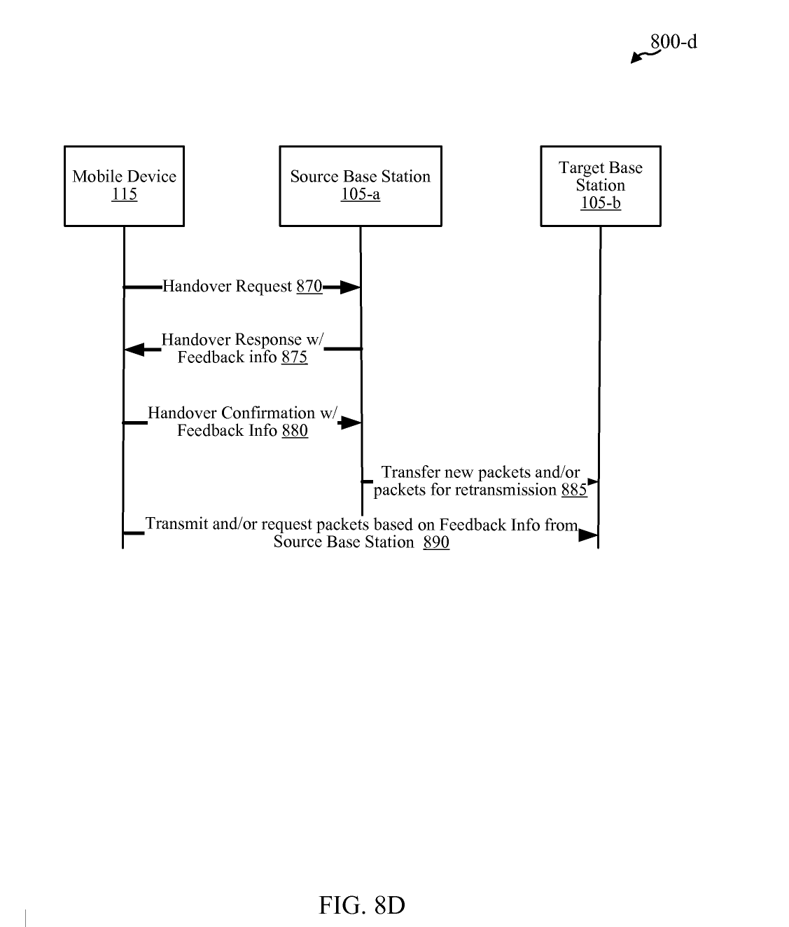

FIG. 8A provides a message sequence flow diagram 800-a in accordance with various embodiments. The message sequence flow of diagram 800-a may be implemented utilizing different devices and/or systems, such as base stations 105 of FIG. 1, mobile devices 115 of FIG. 1, base stations 105-a and/or 105-b of FIG. 2, mobile device 115-a of FIG. 2, device 300 of FIG. 3, mobile device 115-b of FIG. 4, mobile device 115-c of FIG. 5, and/or base station 105-c of FIG. 5. Diagram 800-a shows that source base station 105-a may receive a handover request 805 from the mobile device 115. The handover request 805 may include a MOB_MSHO-REQ in some embodiments. The source base station 105-a may then transmit a handover response 810 to the mobile device 115, which may be a MOB_BSHO-RSP in some embodiments. The mobile device 115 may transmit a handover conformation or indication message 815 to the source base station 105-a that includes feedback status information. In some embodiments, the mobile device 115 may transmit a MOB_HO-IND message with the ARQ Feedback IE. Having received feedback status information, such as ARQ Feedback IEs, the source base station 105-a may know what information, such as SDUs in some embodiments, to transfer 820 to the target base station 105-b. Since the transfer 820 can be done upon receiving handover indication message, such as MOB_HO-IND message, the data transmission, such as MPDU transmission, can resume quickly at the target base station 105-b.

FIG. 8B provides a message sequence flow diagram 800-b in accordance with various embodiments. The message sequence flow of diagram 800-b may be implemented utilizing different devices and/or systems, such as base stations 105 of FIG. 1, mobile devices 115 of FIG. 1, base stations 105-a and/or 105-b of FIG. 2, mobile device 115-a of FIG. 2, device 300 of FIG. 3, mobile device 115-b of FIG. 4, mobile device 115-c of FIG. 5, and/or base station 105-c of FIG. 5. Diagram 800-b shows that target base station 105-b may receive a handover request message 825 with feedback status information from the mobile device 115. The target base station 105-b may then transmit a handover response message 830 to the mobile device 115. This handover response 830 may include the feedback status information that the target base station 105-b may have received from the mobile device 115 and/or the source base station 105-a in some cases. In some embodiments, this exchange of messages between the mobile device 115 and the target base station 105-b may include ranging messages that may include ARQ Feedback IE(s). Through the exchange of feedback status information, the mobile device 115 and/or the target base station 105-b may know what packets may need to be transmitted, such as which ARQ blocks may be transmitted 835.

FIG. 8C provides a message sequence flow diagram 800-c in accordance with various embodiments. The message sequence flow of diagram 800-c may be implemented utilizing different devices and/or systems, such as base stations 105 of FIG. 1, mobile devices 115 of FIG. 1, base stations 105-a and/or 105-b of FIG. 2, mobile device 115-a of FIG. 2, device 300 of FIG. 3, mobile device 115-b of FIG. 4, mobile device 115-c of FIG. 5, and/or base station 105-c of FIG. 5. Diagram 800-c shows that target base station 105-b may receive a handover request with feedback status information from the mobile device 115. Diagram 800-c in shows an example where an uncontrolled handover may occur in which the source base station 105-a may not receive or may receive a handover message from the mobile device 115. The mobile device 115 may perform a handover search 840, which may include performing handover ranging with respect to the target base station 105-b. The target base station 105-b may transmit a handover search response 845 to the mobile device 115. In some embodiments, this handover search response 845 may include a UL-MAP, which may include allocation information elements (e.g., CDMA Allocation IE). The mobile device 115 may transmit a handover request message 850 to the target base station 105-b, which may include a ranging request message. The handover request message 850 may include information regarding the source target base station 105-a, such as source base station identification (BSID) information. The handover request message 850 may also include feedback status information, which may be ARQ Feedback IE(s) in some embodiments. With this information, the target base station 105-b may know which source base station 105-a it may want to communicate with to request data transfers 855. In addition, the target base station 105-b may know what data, such as SDUs, it may want transferred from the source base station 105-a to the target base station 105-b based on the feedback status information. The target base station 105-b may transmit a handover response message 860 to the mobile device 115. This handover response message 860 may include the feedback status information that it may have received from the mobile device 115 and/or the source base station 105-a in some cases. The handover response message 860 may include a ranging response message with ARQ Feedback IE(s) in some embodiments. The mobile device 115 and the target base station 105-b may then transmit data 865 between each other, which may include MPDUs in some embodiments.

FIG. 8D provides a message sequence flow diagram 800-d in accordance with various embodiments. The message sequence flow of diagram 800-d may be implemented utilizing different devices and/or systems, such as base stations 105 of FIG. 1, mobile devices 115 of FIG. 1, base stations 105-a and/or 105-b of FIG. 2, mobile device 115-a of FIG. 2, device 300 of FIG. 3, mobile device 115-b of FIG. 4, mobile device 115-c of FIG. 5, and/or base station 105-c of FIG. 5. Diagram 800-d shows that source base station 105-a may receive a handover request 870 from the mobile device 115. The handover request 870 may include a MOB_MSHO-REQ in some embodiments. The source base station 105-a may then transmit a handover response 875 to the mobile device 115, which may be a MOB_BSHO-RSP in some embodiments. The source base station 105-a may include feedback status information as part of the handover response 875. The mobile device 115 may transmit a handover confirmation or indication message 880 to the source base station 105-a. In some embodiments, the handover confirmation message 880 may include feedback status information from the mobile device 115. In some embodiments, the mobile device 115 may transmit a MOB_HO-IND message. Having received feedback status information, such as ARQ Feedback IEs, the mobile device 115 and/or the source base station 105-a may know what information, such as SDUs in some embodiments, to transfer or transmit 885/890 to the target base station 105-b. Since the transfer 885/890 can be done upon receiving handover confirmation message, such as MOB_HO-IND message, the data transmission, such as MPDU transmission, can resume quickly at the target base station 105-b. In general, the source base station 105-a may transfer 885 new packets and/or packets for retransmission to the target base station 105-b based on feedback status information it may send or receive from mobile device 115. Mobile device 115 may transmit 890 and/or request packets based on feedback information it has received from the source base station 105-a.

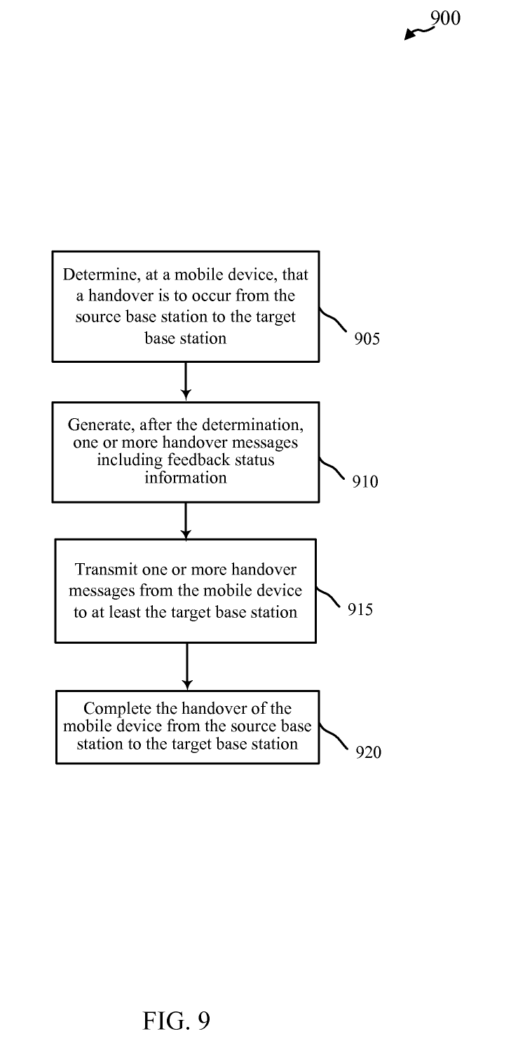

Turning now to FIG. 9, a method 900 of utilizing proactive feedback during handover from a source base station to a target base station is provided. Method 900 may be implemented by different devices and/or systems, such as mobile devices 115 of FIG. 1, mobile device 115-a of FIG. 2, device 300 of FIG. 3, mobile device 115-b of FIG. 4, and/or mobile device 115-c of FIG. 5.

At block 905, a handover is to occur from the source base station to the target base station, which may be determined at the mobile device. At block 910, after the determination, one or more handover messages including feedback status information may be determined. At block 915, one or more handover messages may be transmitted from the mobile device to the target base station. At block 920, the handover of the mobile device from the source base station to the target base station may be completed.

The feedback status information may include information from the mobile device regarding at least one or more packets that the mobile device has received, one or more packets that the mobile device has not received, one or more packets that the mobile device has sent and received one or more acknowledgements, one or more packets that the mobile device has sent without receiving an acknowledgement, or one or more packets that the mobile device has not sent.

Completing the handover of the mobile device from the source base station to the target station may occur after transmitting the one or more handover messages from the mobile device to the target base station.

Method 900 may further include receiving one or more packets based on the feedback status information that was transmitted as part of the one or more handover messages. Receiving the one or more packets based on the feedback status information that was transmitted as part of the one or more handover messages may include receiving one or more retransmitted packets based on the feedback status information that was transmitted as part of the one or more handover messages. Receiving the one or more retransmitted packets based on the feedback status information that was transmitted as part of the one or more handover messages may include receiving the one or more retransmitted packets from the target base station.

Method 900 may further include receiving a handover message from the target base station, wherein the handover message from the target base station includes the feedback status information from the handover message from the mobile device.

The one or more handover messages from the mobile device may include a ranging message transmitted to the target base station. The feedback status information may include one or more automatic repeat request information elements.

Determining the handover may include the mobile device initiating the handover. Determining the handover may include the source base station initiating the handover.

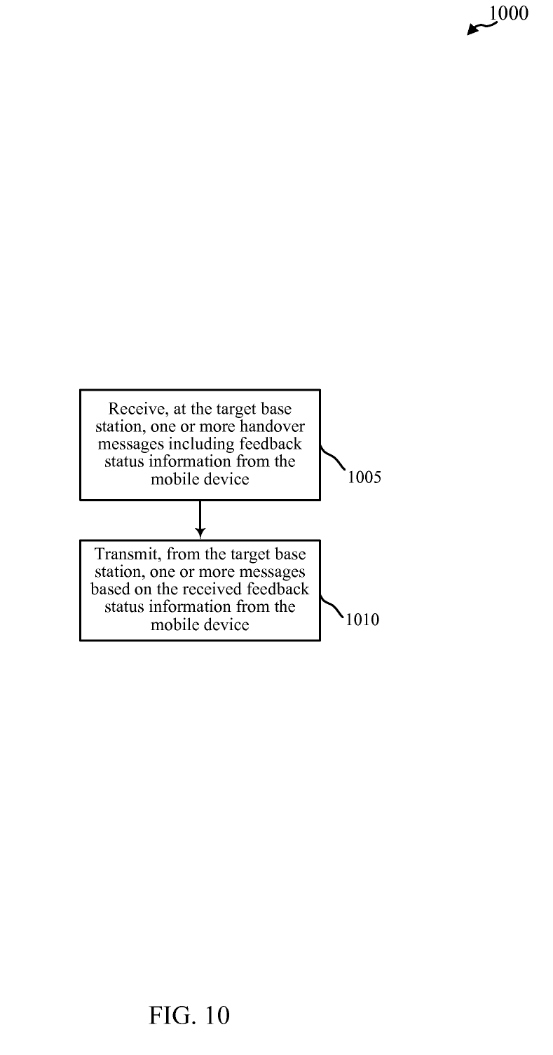

Turning now to FIG. 10, a flow diagram of a method 1000 of utilizing proactive feedback during handover of a mobile device from a source base station to a target base station is provided. Method 1000 may be implemented by different devices and/or systems, such as base stations 105 of FIG. 1, base stations 105-a and/or 105-b of FIG. 2, device 300 of FIG. 3, and/or base station 105-c of FIG. 5.

At block 1005, one or more handover messages including feedback status information from the mobile device may be received at the target base station. At block 1010, one or more messages may be transmitted from the target base station based on the received feedback status information from the mobile device.

Method 1000 may further include transmitting a handover message from the target base station to the mobile device where the handover message from the target base station may include the feedback status information from the handover message from the mobile device.

Transmitting the one or more messages based on the received feedback status information from the mobile device may include transmitting a packet request from the target base station to the source base station based on the received feedback status information. Some embodiments may further include receiving one or more packets from the source base station based on the transmitted packet request. Embodiments may further include transmitting a handover message from the target base station where the handover message from the target base station includes the feedback status information from the handover message from the mobile device.

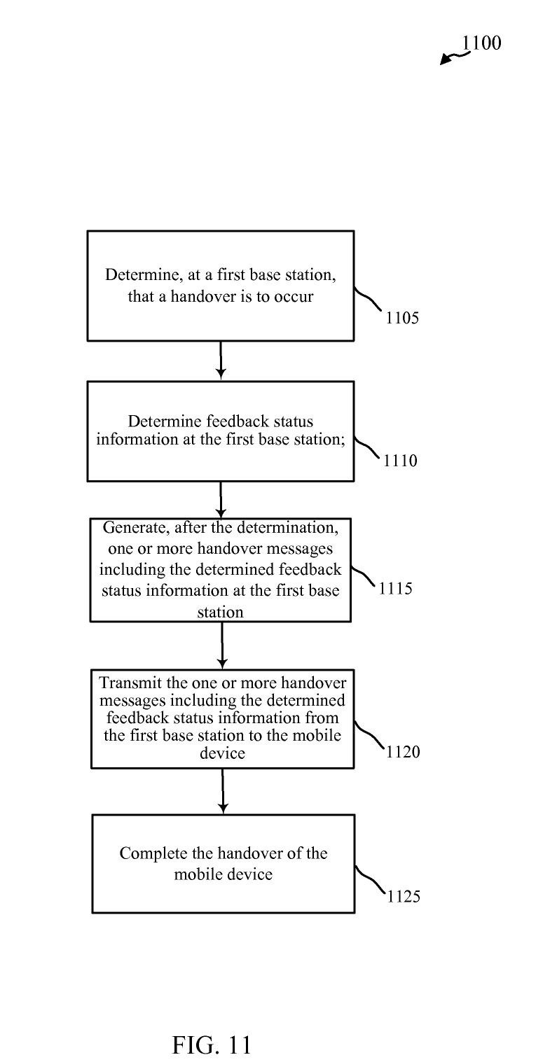

Turning now to FIG. 11, a flow diagram of a method 1100 of utilizing proactive feedback during handover. Method 1100 may be implemented by different devices and/or systems, such as base stations 105 of FIG. 1, base stations 105-a and/or 105-b of FIG. 2, device 300 of FIG. 3, and/or base station 105-c of FIG. 5.

At block 1105, it may be determined, at a first base station, that a handover is to occur. At block 1110, feedback status information may be determined at the first base station. At block 1115, one or more handover messages including the determined feedback status information may be generated, after the determination, at the first base station. At block 1120, the one or more handover messages including the determined feedback status information may be transmitted from the first base station to a mobile device. At block 1125, the handover of the mobile device may be completed.

The feedback status information may include information from the first base station regarding at least one or more packets that the first base station has received, one or more packets that the first base station has not received, one or more packets that the first base station has sent and received one or more acknowledgements, one or more packets that the first base station has sent without receiving an acknowledgement, one or more packets that the first base station has not sent, or feedback information from the mobile device. Completing the handover may occur after transmitting the one or more handover messages with the feedback status information from the first base station to the mobile device.

Some embodiments of method 1100 may further include transmitting one or more messages from the first base station to a second base station based on the determined feedback status information. Transmitting the one or more messages based on the determined feedback status information may include transmitting one or more packets from the first base station to second base station based on the determined feedback status information. Transmitting the one or more packets from the first base station to the second base station based on the transmitted feedback status information may include transmitting at least one or more new packets or retransmitted packets from the first base station to the second base station based on the determined feedback status information.

In some embodiments, the first base station is a source base station. In some embodiments, the first base station is a target base station. In some embodiments, the first base station is a source base station and the second base station is a target base station. In some embodiments, the first base station is a target base station and the second base station is a source base station.

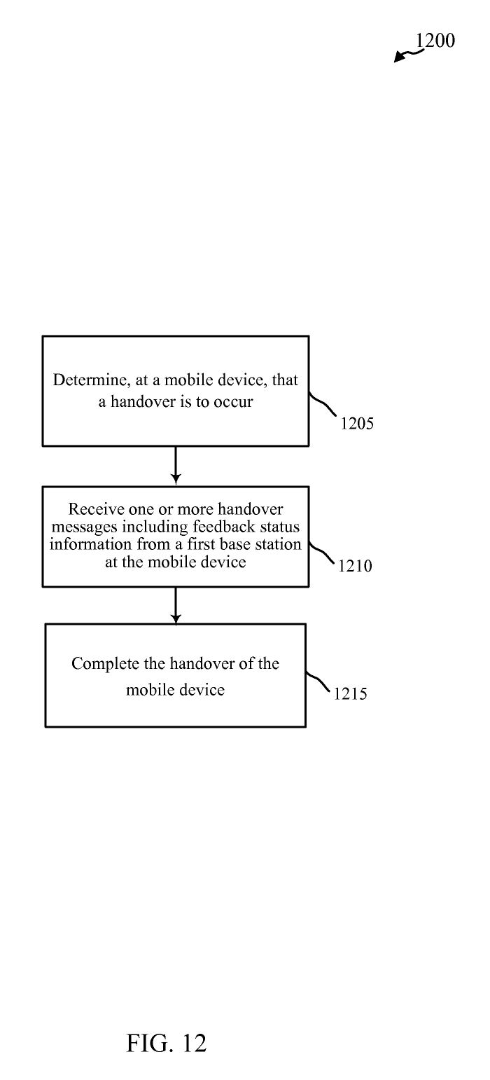

Turning now to FIG. 12, a method 1200 of utilizing proactive feedback during handover is provided. Method 1200 may be implemented by different devices and/or systems, such as mobile devices 115 of FIG. 1, mobile device 115-a of FIG. 2, device 300 of FIG. 3, mobile device 115-b of FIG. 4, and/or mobile device 115-c of FIG. 5.

At block 1205, it may be determined, at a mobile device, that a handover is to occur. At block 1210, one or more handover messages including feedback status information may be received from a first base station at the mobile device. At block 1215, the handover of the mobile device may be completed.

The feedback status information may include information from the first base station regarding at least one or more packets that the first base station has received, one or more packets that the first base station has not received, one or more packets that the first base station has sent and received one or more acknowledgements, one or more packets that the first base station has sent without receiving an acknowledgement, one or more packets that the first base station has not sent, or feedback information from the mobile device. Completing the handover may occur after receiving the one or more handover messages with the feedback status information from the first base station at the mobile device.

In some embodiments, method 1200 may further include transmitting one or more messages from the mobile device station to a second base station based on the received feedback status information. Transmitting the one or more messages based on the received feedback status information may include transmitting one or more packets from the mobile device to the second base station based on the received feedback status information. Transmitting the one or more packets from the mobile device to the second base station based on the transmitted feedback status information may include transmitting at least one or more new packets or retransmitted packets from the mobile device to the second base station based on the received feedback status information.

In some embodiments, the first base station is a source base station. In some embodiments, the first base station is a source base station and the second base station is a target base station.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general-purpose or special-purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

1. A method of utilizing proactive feedback during handover from a source base station to a target base station, the method comprising:
determining, at a mobile device, that a handover is to occur from the source base station to the target base station;
generating, after the determination, one or more handover messages including feedback status information;
transmitting the one or more handover messages including the feedback status information from the mobile device to the target base station; and
completing the handover of the mobile device from the source base station to the target base station.

2. The method of claim 1, wherein the feedback status information includes information from the mobile device regarding at least one or more packets that the mobile device has received, one or more packets that the mobile device has not received, one or more packets that the mobile device has sent and received one or more acknowledgements, one or more packets that the mobile device has sent without receiving an acknowledgement, or one or more packets that the mobile device has not sent.

3. The method of claim 1, wherein completing the handover of the mobile device from the source base station to the target station occurs after transmitting the one or more handover messages from the mobile device to the target base station.

4. The method of claim 1, further comprising:
receiving one or more packets based on the feedback status information that was transmitted as part of the one or more handover messages.

5. The method of claim 4, wherein receiving the one or more packets based on the feedback status information that was transmitted as part of the one or more handover messages comprises:
receiving one or more retransmitted packets based on the feedback status information that was transmitted as part of the one or more handover messages.

6. The method of claim 5, wherein receiving the one or more retransmitted packets based on the feedback status information that was transmitted as part of the one or more handover messages comprises:
receiving the one or more retransmitted packets from the target base station.

7. The method of claim 1, further comprising:
receiving a handover message from the target base station, wherein the handover message from the target base station includes the feedback status information from the handover message from the mobile device.

8. The method of claim 1, wherein the one or more handover messages from the mobile device includes a ranging message transmitted to the target base station.

9. The method of claim 1, wherein the feedback status information includes one or more automatic repeat request information elements.

10. The method of claim 1, wherein determining the handover comprises the mobile device initiating the handover.

11. An apparatus for utilizing proactive feedback during handover from a source base station to a target base station, the apparatus comprising:
a means for determining that a handover is to occur from the source base station to the target base station;
a means for generating, after the determination, one or more handover messages including feedback status information;
a means for transmitting the one or more handover messages including the feedback status information to the target base station; and
a means for completing the handover of the mobile device from the source base station to the target base station.

12. A mobile device configured for utilizing proactive feedback during handover from a source base station to a target base station, the mobile device comprising:
a handover module configured to determine that a handover is to occur from the source base station to the target base station to complete the handover of the mobile device from the source base station to the target base station;
a feedback status module configured to generate, after the determination, one or more handover messages including feedback status information;
a transmitter module configured to transmit the one or more handover messages including the feedback status information from the mobile device to the target base station.

13. The mobile device of claim 12, wherein the feedback status information includes information from the mobile device regarding at least one or more packets that the mobile device has received, one or more packets that the mobile device has not received, one or more packets that the mobile device has sent and received one or more acknowledgements, one or more packets that the mobile device has sent without receiving an acknowledgement, or one or more packets that the mobile device has not sent.

14. The mobile device of claim 12, further comprising:
a receiver module configured to receive one or more packets based on the feedback status information that was transmitted as part of the one or more handover messages.

15. The mobile device of claim 14, wherein receiving the one or more packets based on the feedback status information that was transmitted as part of the one or more handover messages comprises:
receiving one or more retransmitted packets based on the feedback status information that was transmitted as part of the one or more handover messages.

16. The mobile device of claim 15, wherein receiving the one or more retransmitted packets based on the feedback status information that was transmitted as part of the one or more handover messages comprises:
receiving the one or more retransmitted packets from the target base station.

17. A computer program product for utilizing proactive feedback during handover from a source base station to a target base station comprising:
a non-transitory computer-readable medium comprising:
code for determining, at a mobile device, that a handover is to occur from the source base station to the target base station;
code for generating, after the determination, one or more handover messages including feedback status information;
code for transmitting the one or more handover messages including the feedback status information from the mobile device to the target base station; and
code for completing the handover of the mobile device from the source base station to the target base station.

18. A method of utilizing proactive feedback during a handover of a mobile device from a source base station to a target base station, the method comprising:
receiving, at the target base station, one or more handover messages including feedback status information from the mobile device; and
transmitting, from the target base station, one or more messages based on the received feedback status information from the mobile device.

19. The method of claim 18, further comprising:
transmitting a handover message from the target base station to the mobile device, wherein the handover message from the target base station includes the feedback status information from the handover message from the mobile device.

20. The method of claim 18, wherein transmitting the one or more messages based on the received feedback status information from the mobile device comprises:
transmitting a packet request from the target base station to the source base station based on the received feedback status information.

21. The method of claim 20, further comprising:
receiving one or more packets from the source base station based on the transmitted packet request; and
transmitting a handover message from the target base station, wherein the handover message from the target base station includes the feedback status information from the handover message from the mobile device.

22. An apparatus configured for utilizing proactive feedback during a handover of a mobile device from a source base station to a target base station, the apparatus comprising:
a means for receiving, at the target base station, one or more handover messages including feedback status information from the mobile device; and
a means for transmitting, from the target base station, one or more messages based on the received feedback status information from the mobile device.

23. A target base station configured for utilizing proactive feedback during a handover of a mobile device from a source base station to the target base station, the target base station comprising:
a receiver module configured to receive, at the target base station, one or more handover messages including feedback status information from the mobile device; and
a transmitter module configured to transmit, from the target base station, one or more messages based on the received feedback status information from the mobile device.

24. The target base station of claim 23, wherein transmitting the one or more messages based on the received feedback status information from the mobile device comprises:
transmitting a packet request from the target base station to the source base station based on the received feedback status information.

25. The target base station of claim 24, further configured to:
receive one or more packets from the source base station based on the transmitted packet request; and
transmit a handover message from the target base station, wherein the handover message from the target base station includes the feedback status information from the handover message from the mobile device.

26. A computer program product for utilizing proactive feedback during a handover of a mobile device from a source base station to a target base station comprising:
a non-transitory computer-readable medium comprising:
code for receiving, at the target base station, one or more handover messages including feedback status information from the mobile device; and
code for transmitting, from the target base station, one or more messages based on the received feedback status information from the mobile device.

27. A method of utilizing proactive feedback during handover, the method comprising:
determining, at a mobile device, that a handover is to occur;
receiving one or more handover messages including feedback status information from a first base station at the mobile device; and
completing the handover of the mobile device.

28. The method of claim 27, wherein the feedback status information includes information from the first base station regarding at least one or more packets that the first base station has received, one or more packets that the first base station has not received, one or more packets that the first base station has sent and received one or more acknowledgements, one or more packets that the first base station has sent without receiving an acknowledgement, one or more packets that the first base station has not sent, or feedback information from the mobile device.

29. The method of claim 27, wherein completing the handover occurs after receiving the one or more handover messages with the feedback status information from the first base station at the mobile device.

30. The method of claim 27, further comprising:
transmitting one or more messages from the mobile device station to a second base station based on the received feedback status information.

31. The method of claim 30, wherein transmitting the one or more messages based on the received feedback status information comprises:
transmitting one or more packets from the mobile device to the second base station based on the received feedback status information.

32. The method of claim 31, wherein transmitting the one or more packets from the mobile device to the second base station based on the transmitted feedback status information comprises:
transmitting at least one or more new packets or retransmitted packets from the mobile device to the second base station based on the received feedback status information.

33. An apparatus for utilizing proactive feedback during handover, the apparatus comprising:
a means for determining, at a mobile device, that a handover is to occur;
a means for receiving one or more handover messages including feedback status information from a first base station at the mobile device; and
a means for completing the handover of the mobile device.

34. A mobile device configured for utilizing proactive feedback during handover, the mobile device comprising:
a handover module configured to:
determine, at the mobile device, that a handover is to occur; and
complete the handover of the mobile device; and
a receiver module configured to receive one or more handover messages including feedback status information from a first base station at the mobile device.

35. The mobile device of claim 34, wherein the feedback status information includes information from the first base station regarding at least one or more packets that the first base station has received, one or more packets that the first base station has not received, one or more packets that the first base station has sent and received one or more acknowledgements, one or more packets that the first base station has sent without receiving an acknowledgement, one or more packets that the first base station has not sent, or feedback information from the mobile device.

36. The mobile device of claim 34, wherein completing the handover occurs after receiving the one or more handover messages with the feedback status information from the first base station at the mobile device.

37. The mobile device of claim 34, further comprising:
a transmitter module configured to transmit one or more messages from the mobile device station to a second base station based on the received feedback status information.

38. The mobile device of claim 37, wherein transmitting the one or more messages based on the received feedback status information comprises:
transmitting one or more packets from the mobile device to the second base station based on the received feedback status information.

39. The mobile device of claim 38, wherein transmitting the one or more packets from the mobile device to the second base station based on the transmitted feedback status information comprises:
transmitting at least one or more new packets or retransmitted packets from the mobile device to the second base station based on the received feedback status information.

40. A computer program product for utilizing proactive feedback during handover comprising:
a non-transitory computer-readable medium comprising:
code for determining, at a mobile device, that a handover is to occur;
code for receiving one or more handover messages including feedback status information from a first base station at the mobile device; and
code for completing the handover of the mobile device.
